(19) United States
(12) Patent Application Publication
(10) Pub. No.: US 2014/0362104 A1
(43) Pub. Date: Dec. 11, 2014

(54) LAYERED Z-ORDER AND HINTED COLOR FONTS WITH DYNAMIC PALETTES

(71) Applicant: Microsoft Corporation, Redmond, WA (US)

(72) Inventors: Gregory Hitchcock, Woodinville, WA (US); Niklas Borson, Langley, WA (US); Tanya Matskewich, Redmond, WA (US)

(21) Appl. No.: 13/915,225

(22) Filed: Jun. 11, 2013

(51) Int. Cl. G09G 5/06; G09G 5/24

(52) U.S. Cl. CPC G09G 5/06; G09G 5/24
USPC 345/593

(57) ABSTRACT

Technologies are generally provided for a set of data structures and font design techniques residing in a font file that enables the rich use of color that can be scaled for many devices with many resolutions and displayed on many types of colored backgrounds. Glyphs in a font may be ordered to provide z-ordering of layered color data. Multiple palettes may be provided within a font to handle multiple scenarios, including varying backgrounds. Furthermore, operating system text color choice may be integrated with the font designer's choice of colors, and the colored elements in a glyph may be hinted to improve the display of color on many different devices. A fall back to a non-colored glyph may also be provided when color is not supported on a platform or application.

### BACKGROUND

Despite considerable advances in video and audio output technologies, the main interaction technique with a computing device still remains textual and graphic display output. Since the early days of computing, when textual output was the sole output of a computer, graphic (and video) technologies have come a long way. Indeed, the lines between text and graphics are becoming blurrier as time passes. Textual output, which was traditionally defined as alphanumeric characters, now includes increasing varieties of graphic elements such as icons, emoticons, etc.

Textual characters (and now icons) can be grouped and categorized in “fonts”. While technically, a font designates a specific member of a type family such as roman, boldface, or italic type, and a typeface designates a consistent visual appearance or style which can be a family or related set of fonts. For example, a given typeface such as Arial may include roman, bold, and italic fonts. However, common uses of the terms font and typeface rarely distinguish between the two.

Scalable fonts have been proven useful for graphical elements such as icons, but adding color has historically been challenging because of the inability of the font to provide z-ordering of separate elements. Moreover, color in the fonts may work well with some backgrounds but not others. Thus, conventional extended fonts (those including graphic elements) are either limited in their offering of color, or scalability.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a set of data structures and font design techniques residing in a font file that enables the rich use of color that can be scaled for many devices with many resolutions and displayed on many types of colored backgrounds. According to some examples, glyphs in a font may be ordered to provide z-ordering of layered color data. Multiple palettes may be provided within a font to handle multiple scenarios, including varying backgrounds. Furthermore, operating system text color choice may be integrated with the font designer's choice of colors using a reserved palette index, and the colored elements in a glyph may be hinted to improve the display of color on many different devices. A fall back to a non-colored glyph may also be provided when color is not supported on a platform or application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates conceptually display of a character based on look-up of glyphs from a character code;

FIG. 2 illustrates an example character display based on layered look-up tables and color palettes according to some embodiments;

FIG. 3 illustrates conceptually layered formation of a character based on base and replacement glyphs and color palettes for each replacement glyph according to some embodiments;

FIG. 4 is a networked environment, where a system according to embodiments may be implemented;

FIG. 5 is a block diagram of an example computing operating environment, where embodiments may be implemented;

FIG. 6 illustrates a logic flow diagram for a process of providing layered z-order and hinted color fonts with dynamic palettes according to embodiments.

### DETAILED DESCRIPTION

As briefly described above, glyphs in a font may be ordered to provide z-ordering of layered color data, and multiple palettes may be provided within a font to handle multiple scenarios, including varying backgrounds. Operating system text color choice may be integrated with the font designer's choice of colors, and the colored elements in a glyph may be hinted to improve the display of color on many different devices. A fall back to a non-colored glyph may also be provided when color is not supported on a platform or application.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable physical media.

Throughout this specification, the term “platform” may be a combination of software and hardware components for providing layered z-order and hinted color fonts with dynamic palettes. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

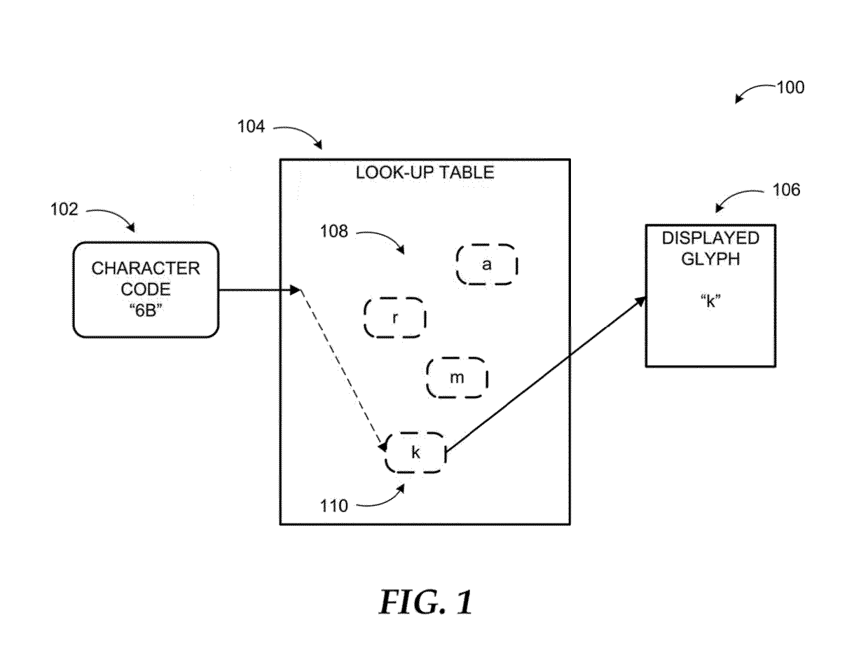

Referring to FIG. 1, diagram 100 illustrates conceptually display of a character based on look-up of glyphs from a character code. The characters and environments shown in diagram 100 are for illustration purposes. Embodiments may be implemented in various local, networked, and similar computing environments employing a variety of computing devices and systems.

In professional typography, the term font is historically defined as a given alphabet and its associated characters in a single size. The term typeface designates a specific member of a type family such as roman, boldface, or italic type. Thus, a given typeface such as Arial may include roman, bold, and italic fonts. A font may also refer a specific point size. However, in the digital era, the definition distinctions have blurred and in common use, the term font is generally understood to refer to a family of characters with different sizes and attributes such as italic, bold, and similar ones. A more precise use/definition may be “the font family”, which is typically used to refer to a group of related fonts which vary only in weight, orientation, width, etc., but not design. For example, Times is a font family, whereas Times Roman, Times Italic and Times Bold are individual typefaces making up the Times family. Font families may typically include several fonts, though some, such as Helvetica, may include dozens of fonts.

A computer font is an electronic data file containing a set of glyphs, characters, or symbols such as dingbats. There are three basic kinds of computer font file data formats: (1) bitmap fonts that include a matrix of dots or pixels representing the image of each glyph in each face and size; (2) outline fonts (also called vector fonts) that use Bézier curves, drawing instructions, and mathematical formulas to describe each glyph, which make the character outlines scalable to any size; (3) and stroke fonts that use a series of specified lines and additional information to define the profile, or size and shape of the line in a specific face, which together describe the appearance of the glyph.

Bitmap fonts are faster and easier to use in computer code, but non-scalable, requiring a separate font for each size. Outline and stroke fonts may be resized using a single font and substituting different measurements for components of each glyph, but may be somewhat more complicated to render on screen than bitmap fonts, as they are involved with additional computer code to render the outline to a bitmap for display on screen or in print.

A bitmap font is one that stores each glyph as an array of pixels (that is, a bitmap). It is less commonly known as a raster font. Bitmap fonts are simply collections of raster images of glyphs. For each variant of the font, there is a complete set of glyph images, with each set containing an image for each character. For example, if a font has three sizes, and any combination of bold and italic, then there needs to be 12 complete sets of images.

A raster image may be displayed in a different size only with some distortion, but renders quickly; outline or stroke image formats are resizable but may take more time to render as pixels need to be drawn from scratch each time they are displayed. Fonts are designed and created using font editors. Fonts specifically designed for the computer screen are known as screen fonts. Fonts may be mono-spaced (i.e., every character is plotted a constant distance from the previous character that it is next to, while drawing) or proportional (each character has its own width). However, a particular font-handling application can affect the spacing, particularly when doing justification.

Outline fonts or vector fonts are collections of vector images, that is, a set of lines and curves to define the border of glyphs. Examples of outline fonts include, but are not limited to, PostScript Type 1 and Type 3 fonts, TrueType and OpenType.

The primary advantage of outline fonts is that they can be easily transformed by applying a mathematical function to each vector point, scaling them without causing pixellation. Outline font characters may be scaled to any size and otherwise transformed with more attractive results than bitmap fonts, but may require considerably more processing and may yield undesirable rendering, depending on the font, rendering software, and output size. A disadvantage of outline fonts is that Bézier curves cannot be rendered accurately onto a raster display (such as most computer monitors and printers), and their rendering may change shape depending on the desired size and position. Measures such as font hinting may have to be used to reduce the visual impact of this challenge.

In stroke-based fonts, a glyph's outline is defined by the vertices of individual strokes and stroke's profile. The advantages of stroke-based fonts over outline fonts include reducing number of vertices needed to define a glyph, allowing the same vertices to be used to generate a font with a different weight, glyph width, or serifs using different stroke rules, and the associated size savings. Editing a glyph by stroke may be easier and less prone to error compared to editing outlines. A stroke-based system may also allow scaling glyphs in height or width without altering stroke thickness of the base glyphs.

The limited processing power and memory of early computer systems forced exclusive use of bitmap fonts. Improvements in hardware have allowed bitmap fonts to be replaced with outline or stroke fonts in cases where arbitrary scaling is desirable, but bitmap fonts are still in common use in embedded systems and other places where speed and simplicity are considered important.

In the example of diagram 100, a character code 102 provided by an application that renders text and/or other data on a screen may be compared to a number of glyphs 108 in a look-up table 104. The glyph 110 corresponding to the character code 102 may then be selected and used to display a glyph 106 on the computing device's screen (or print).

As mentioned previously, adding color has historically been challenging because of the inability of the font to provide z-ordering of separate elements. Using color bitmaps in a font is not difficult and does not require Z-ordering, but does not scale to different sizes. Adding color glyphs to outline or stroke fonts is more challenging because the outlines (or strokes) only specify the shape of a glyph, not its color. There are vector graphics formats that support color (e.g., SVG), but these have not been optimized for use in fonts—for example, they do not support hinting. Moreover, color in the fonts may work well with some backgrounds but not others. Thus, conventional extended fonts (those including graphic elements) are either limited in their offering of color, or scalability.

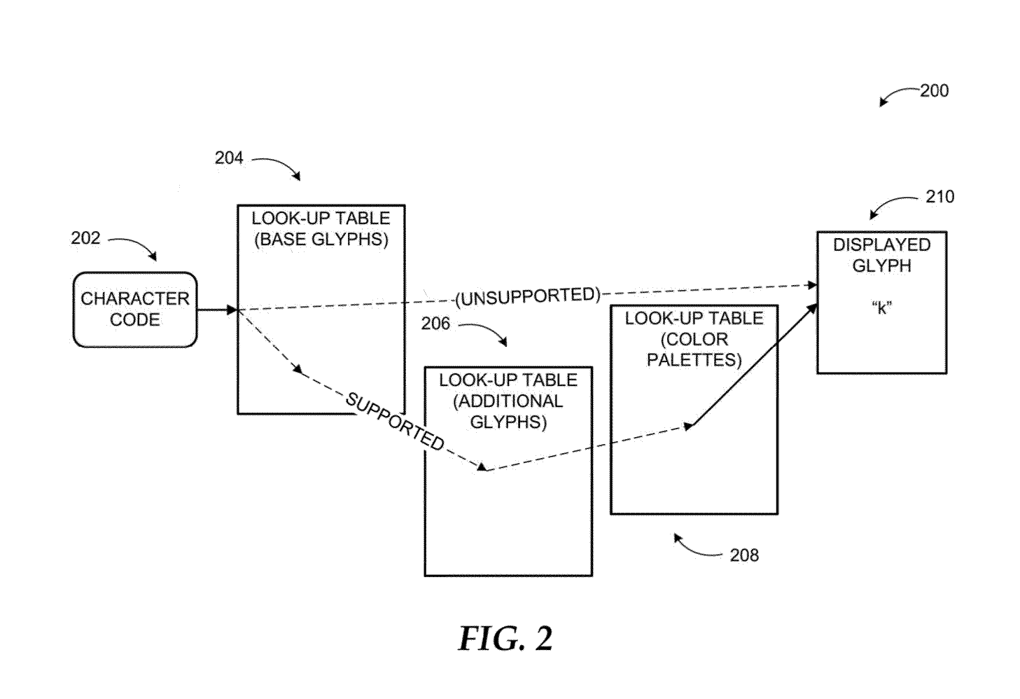

FIG. 2 illustrates an example character display based on layered look-up tables and color palettes according to some embodiments.

The ability to display alternate colors with different palettes may be used to improve the quality of the icons. Since fonts are traditionally selected with an associated color, there needs to be a way to integrate that color with a font designer's intention for color. In a system according to some embodiments, font hinting may be used to dynamically adjust where color appears and where it does not to prevent the display of a colored confusion at small sizes or on low-density displays.

Embodiments provide a set of data structures and font design techniques residing in a font file that enables the rich use of color that can be scaled for many devices with many resolutions and displayed on many types of colored backgrounds. In a system according to some embodiments, glyphs in a font may be ordered to provide z-ordering of layered color data, and multiple palettes may be provided within a font to handle multiple scenarios, including varying backgrounds. According to other embodiments, operating system text color choice may be integrated with the font designer's choice of colors, and the colored elements in a glyph may be hinted to improve the display of color on many different devices. Furthermore, a fallback may be provided to a non-colored glyph when color is not supported on a platform or application.

The traditional method of displaying a character in a font is to pass the desired character code into a look-up table in the font that maps character codes to glyph indices as discussed above in conjunction with FIG. 1. The glyph index is then used to display the glyph. The glyph index is referred to as the base glyph index herein. In a system according to embodiments, the behavior is consistent with traditional systems if the font is used on a device without color support or by an application that does not support color. If color is supported, then the base glyph index may be used as an index into a new table to determine if there is a color variation for a particular base glyph. This table may include a list of replacement glyphs associated with the base glyph. These replacement glyphs may be listed in bottom-up z-order such that when displayed one on top of the next, they may provide a representation of the base glyph. Each of these replacement glyphs may be associated with a color palette index that is applied to every element in that glyph. When all of the glyphs are displayed layered with the color palette index applied, a color representation of the base glyph may be shown.

While in some embodiments a lookup table may be used to map the base glyph to one or more replacement glyphs, a more involved text formatting process may be implemented in other embodiments. In some languages (e.g., Arabic) the same character may have different shapes (represented as different glyphs) depending on context. Even in English, fonts sometimes define special glyphs for certain combinations of characters, called ligatures. In such a text formatting process, characters and formatting information may be taken as input and glyphs and positioning information produced as output. The glyphs may then be rendered immediately, sent to another device (such as a printer) for rendering, or stored in a file (such as PDF or OXPS) for later use.

Embodiments may also be used to add color support without changing the text formatting process, regardless of which text formatting process is used, because the process takes the base glyphs produced by the test formatting process as input and produces color glyphs as output. In addition, embodiments may interoperate with existing devices and file formats that render or otherwise consume glyphs. For example, the color processing may be inserted in between the text layout process (which produces glyphs) and a printer (which renders glyphs), enabling printing of color text without any changes to text layout process or existing printers.

According to some embodiments, another data structure may be provided in the font in a separate location. By providing the data in a separate location, the information may be enabled to be “plug replaceable” with minimal effort. This additional data structure may describe multiple palettes. Each palette may take the index provided by the earlier mentioned replacement glyphs and maps the index to a set of color values, optionally with alpha values. The palettes may be optimized for many different scenarios, from optimizing for light or dark backgrounds to changing the colors of a font based on a system wide theme, to changing subtleties of color based on cultural preferences. One or more palette indices may be reserved to indicate the user or application or system text color. Furthermore, some of the replacement glyphs may reference these reserved indices to integrate user/application/system choice with the font designer's choice of color. The font designer may choose where the reserved color is applied in the overall colored glyph.

Diagram 200 shows an example flow in rendering a character. Character code 202 may be used to look up a base glyph in look-up table 204. If color is not supported by the platform (application or device), the corresponding glyph may be used to display the character (210) as discussed above. If color is supported, a second look-up table 206 of replacement glyphs may be used to find replacement glyph(s) associated with the base glyph and color palette entries, which match palette indices to RGBA values may be determined In alternative embodiments, a third look-up table 208 of color palettes may be used to find color palettes for each of the replacement glyphs. The set of glyphs may then be combined in a z-ordered fashion with the corresponding color palette applied such that the combined colored glyph can be displayed as the colored glyph (210).

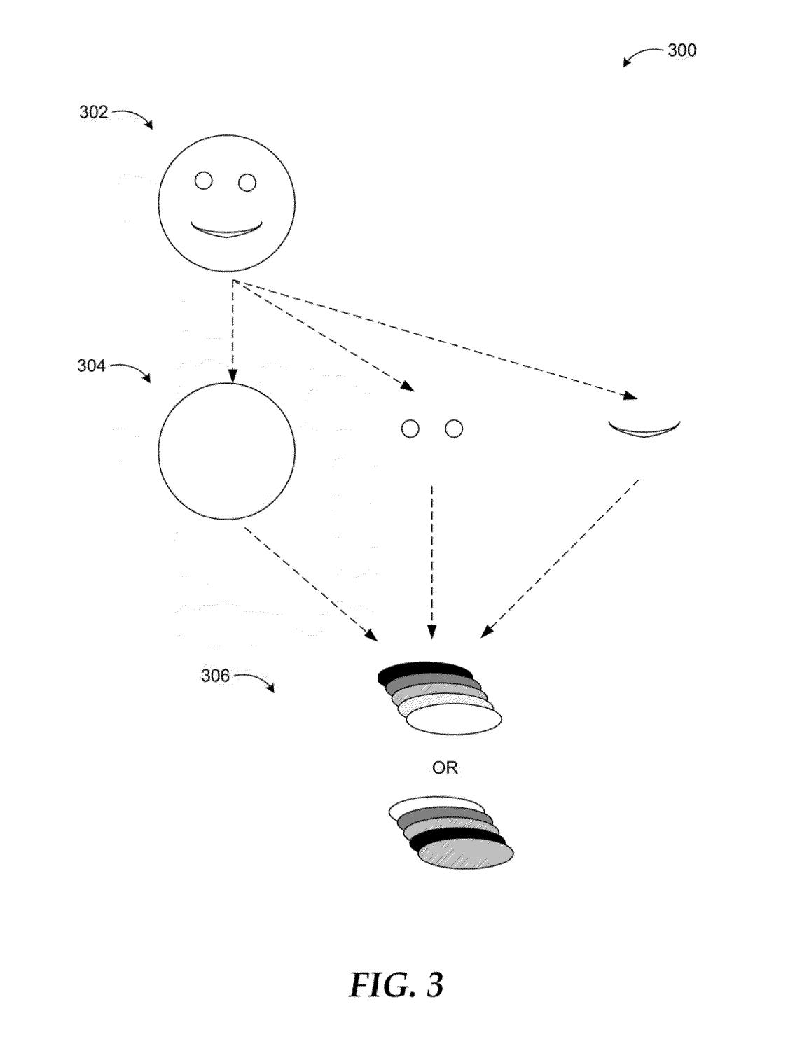

FIG. 3 illustrates conceptually layered formation of a character based on base and replacement glyphs and color palettes for each replacement glyph according to some embodiments.

Diagram 300 shows a base glyph 302 that may be used to determine if there is a color variation for it. The replacement glyphs 304 associated with the base glyph 302 may be listed in bottom-up z-order such that when displayed one on top of the next, they may provide a representation of the base glyph. Each of the replacement glyphs 304 may be associated with a color palette index 306 that is applied to every element in that glyph. Palette index 306 may take the index provided by the replacement glyphs 304 and map the index to a set of color values.

As mentioned above, the palettes may be optimized for optimization based on light or dark backgrounds, modification of the colors of a font based on a system wide theme, localization of color (e.g., based on cultural preferences), and comparable purposes. Since colored layered glyphs may ultimately represent complex images, the complexity of the color may be too much to properly display when scaling the images to very small sizes or displaying the glyphs on low-resolution screens. In some embodiments, font hinting may be used to simplify the colors used, removing some or accentuating others. Font hinting may even remove an entire color layer for a certain size or resolution range, allowing the optimal display of the colored glyph.

Font hinting is the use of mathematical instructions to adjust the display of an outline font so that it lines up with a rasterized grid. At low screen resolutions, font hinting may be used for producing clear, legible text. For the purpose of on-screen text display, font hinting may designate which primary pixels are interpolated to more clearly render a font. Font hinting may be accompanied by antialiasing and/or sub-pixel rendering for further clarity. A font may be hinted either automatically (through processed algorithms based on the character outlines) or set manually.

The examples in FIG. 1 through 3 have been described with specific configurations, characters, and fonts. Embodiments are not limited to these example configurations, characters, and fonts. Layered z-order and hinted color fonts with dynamic palettes may be implemented in configurations using other types of components, processes, and configurations in a similar manner using the principles described herein.

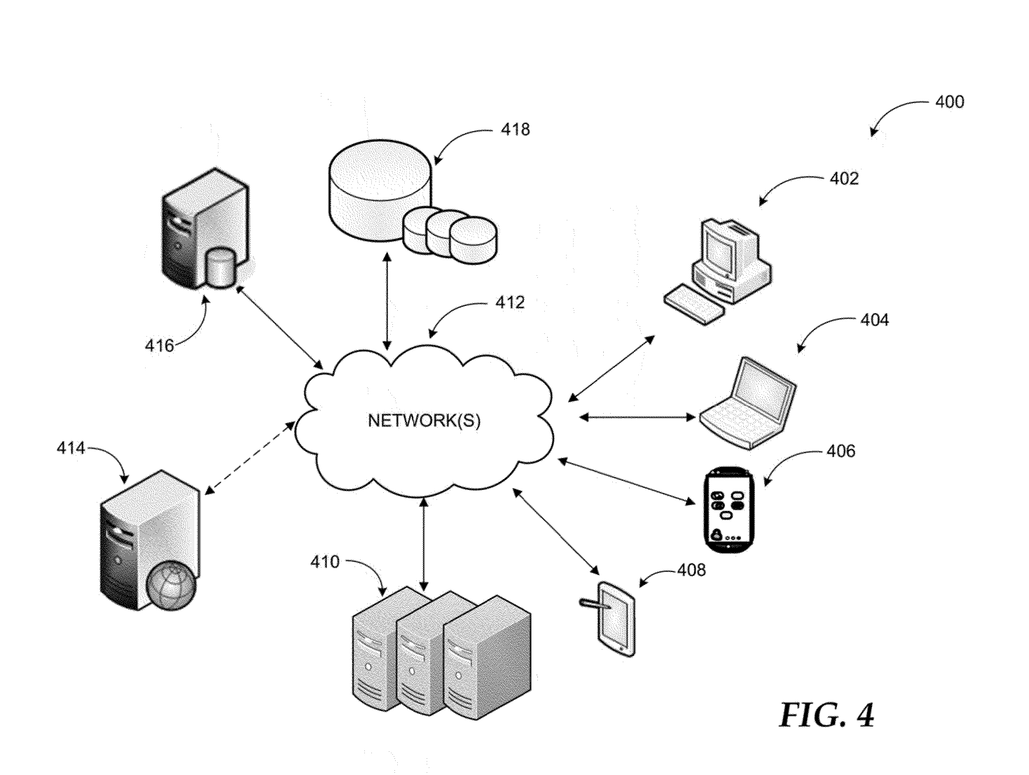

FIG. 4 is an example networked environment, where embodiments may be implemented. A system for providing layered z-order and hinted color fonts with dynamic palettes may be implemented via software executed over one or more servers 410 such as a hosted service as shown in diagram 400. The platform may communicate with client applications on individual computing devices such as a desktop computer 402, a laptop computer 404, a smart phone 406, or a tablet 408 (‘client devices’) through network(s) 412. An application handling fonts as described herein may also be a web application provided by a web server 414.

Client applications executed on any of the client devices 402-408 may communicate with an application executed on one or more of servers 410. A font handling module executed in conjunction with the application may facilitate layered z-order and hinted color fonts with dynamic palettes as discussed previously. The font handling application may retrieve relevant data from data store(s) 418 directly or through database server 416, and render the colored characters through screens associated with client devices 402-408.

Network(s) 412 may comprise any topology of servers, clients, Internet service providers, and communication media. A system according to embodiments may have a static or dynamic topology. Network(s) 412 may include secure networks such as an enterprise network, an unsecure network such as a wireless open network, or the Internet. Network(s) 412 may also coordinate communication over other networks such as Public Switched Telephone Network (PSTN) or cellular networks. Furthermore, network(s) 412 may include short range wireless networks such as Bluetooth or similar ones. Network(s) 412 provide communication between the nodes described herein. By way of example, and not limitation, network(s) 412 may include wireless media such as acoustic, RF, infrared and other wireless media.

Many other configurations of computing devices, applications, data sources, and data distribution systems may be employed to implement a platform providing layered z-order and hinted color fonts with dynamic palettes. Furthermore, the networked environments discussed in FIG. 4 are for illustration purposes only. Embodiments are not limited to the example applications, modules, or processes.

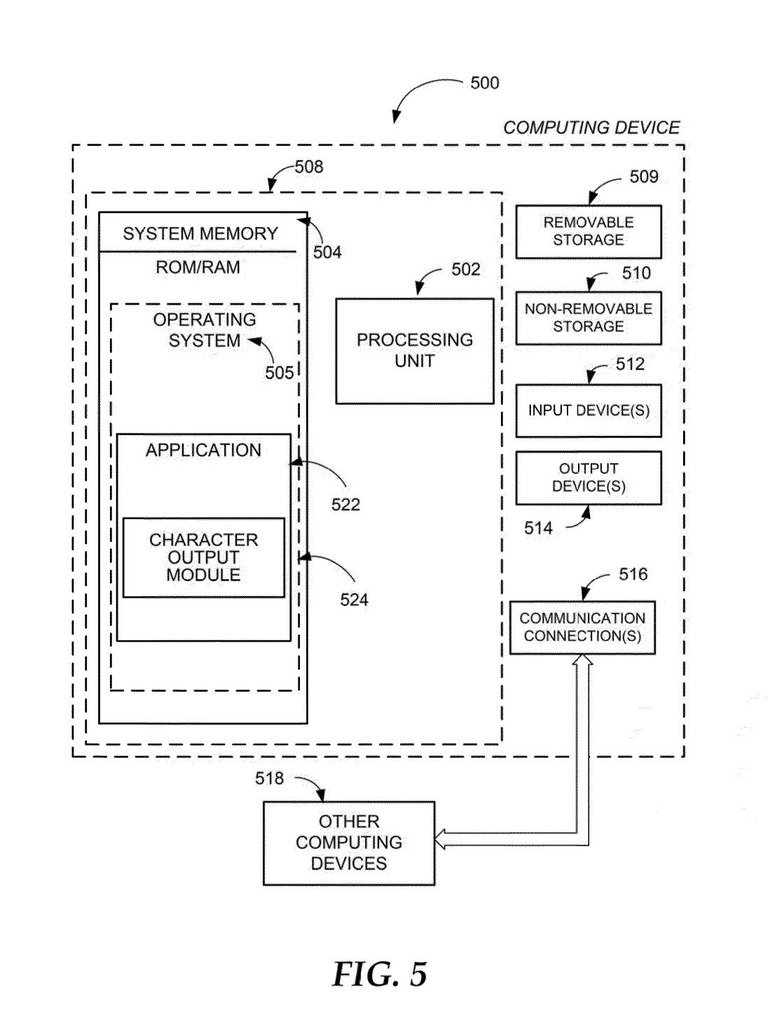

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application handling fonts for rendering according to embodiments, and may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from Microsoft Corporation of Redmond, Wash. The system memory 504 may also include one or more software applications such as font handling spreadsheet application 522, and character output module 524.

The font-handling application 522 may provide functionalities and capabilities for providing layered z-order and hinted color fonts with dynamic palettes in conjunction with the character output module 524. The font handling application 522 and character output module 524 may be separate applications or integrated modules of a hosted service. In some embodiments, the font handling functionality may be part of the operating system 505. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

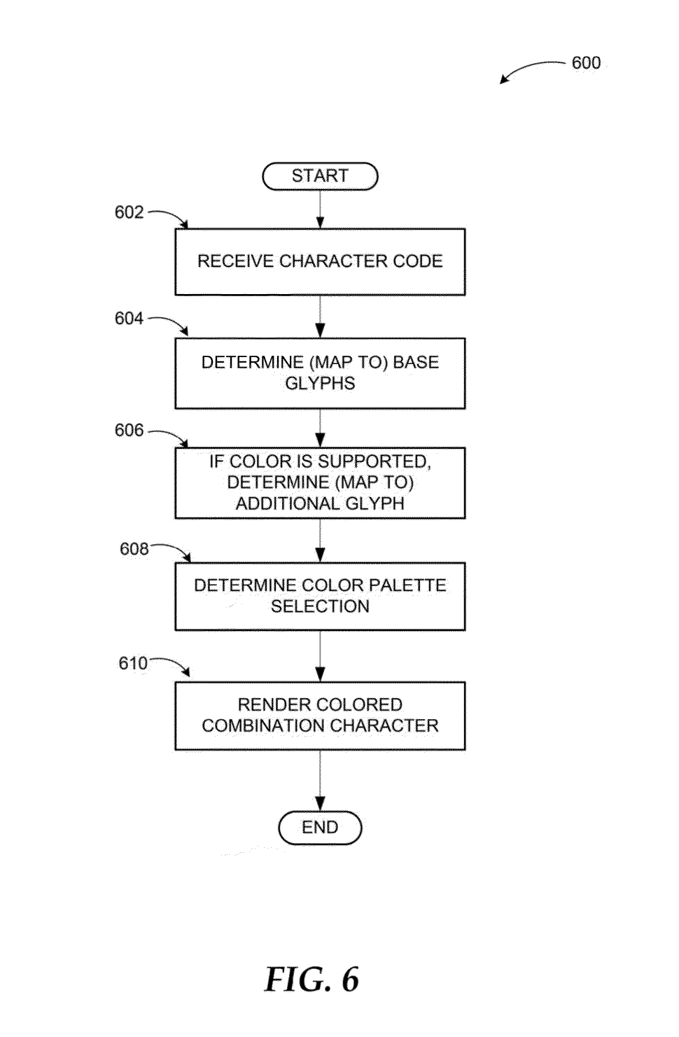

FIG. 6 illustrates a logic flow diagram for process 600 of providing layered z-order and hinted color fonts with dynamic palettes according to embodiments. Process 600 may be implemented on any computing device capable of displaying textual and graphic data.

Process 600 begins with operation 602, where a character code for a character (alphanumeric or graphic) to be displayed is received. Upon determining a base glyph corresponding to the received character code through a base glyph look-up table at operation 604, a second look-up table may be checked for the base glyph to determine if replacement glyphs (indicating color variations for the base glyph) exist at operation 606. Each of these glyphs may have a palette index. The color of the palette index may be determined by which palette is chosen.

At operation 608, a color for any replacement glyphs may be determined through applying the palette index to the chosen palette. The palette may be pre-chosen and applied at least to the whole character, but more often to the whole font. The combined glyph with the color palette applied may then be rendered at operation 610.

In further embodiments, a computer-readable memory device may include instructions stored thereon for providing layered z-order and hinted color fonts with dynamic palettes. The computer-readable memory device may include any physical data storage device remotely or locally accessible to a computing device executing those instructions. The instructions may include the actions discussed above.

The operations included in process 600 are for illustration purposes. Providing layered z-order and hinted color fonts with dynamic palettes may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing layered z-order and hinted color fonts with dynamic palettes, the method comprising:
receiving a character code;
determining a base glyph corresponding to the received character code;
determining if color is supported by a platform for rendering a glyph based on the received character code;
if color is supported, determining one or more replacement glyphs associated with the base glyph;
determining a color palette for the replacement glyphs; and
rendering the glyph corresponding to the character code by combining the one or more replacement glyphs in z-ordered layers and applying the color palette.

2. The method of claim 1, further comprising:
if color is not supported rendering the base glyph.

3. The method of claim 1, wherein determining the base glyph and the one or more replacement glyphs comprises:
mapping the received character code to the base glyph; and
mapping the base glyph to the one or more replacement glyphs.

4. The method of claim 1, further comprising:
providing multiple palettes within a font to handle multiple scenarios, including varying backgrounds.

5. The method of claim 1, further comprising:
integrating an operating system text color choice with a font designer's choice of colors using a reserved palette index.

6. The method of claim 1, further comprising:
employing font hinting on colored elements in the combined glyph to improve a display of color on different devices or application user interfaces.

7. The method of claim 1, further comprising:
providing available replacement glyphs and available color palettes in separate data structures within a font file.

8. The method of claim 1, further comprising:
listing the replacement glyphs in the look-up table in a bottom-up z-order such that when displayed, the replacement glyphs provide a representation of the base glyph.

9. The method of claim 1, further comprising:
applying the color palette to every element of the corresponding replacement glyphs.

10. The method of claim 1, wherein each color palette maps an index of the replacement glyphs to a set of color values.

11. The method of claim 10, wherein each color palette also includes alpha values.

12. A computing device operable to provide layered z-order and hinted color fonts with dynamic palettes, the computing device comprising:
a memory;
a processor coupled to the memory, the processor executing the character output module integrated with a font handling application, the character output module configured to:
receive a character code, wherein the character code indicates one of an alphanumeric character and a graphic element;
determine a base glyph corresponding to the received character code;
determine if color is supported by a platform for rendering a glyph based on the received character code;
if color is supported, determine one or more replacement glyphs associated with the base glyph;
determine a color palette for the replacement glyphs; and
render the glyph corresponding to the character code by combining the one or more replacement glyphs in z-ordered layers and applying the color palette.

13. The computing device of claim 12, wherein the color palettes are optimized for varying backgrounds.

14. The computing device of claim 12, wherein the color palettes are optimized for changing colors of a font based on a system wide theme.

15. The computing device of claim 12, wherein the color palettes are optimized for changing colors of a font based localization preferences.

16. The computing device of claim 12, wherein one or more palette indices are reserved to indicate one or more of a user, an application, and a system character color.

17. The computing device of claim 16, wherein at least one of the one or more replacement glyphs references the reserved indices to integrate one or more or a user choice, an application choice, and a system choice with a font designer's choice of color.

18. A computer-readable memory device with instructions stored thereon for providing layered z-order and hinted color fonts with dynamic palettes, the instructions comprising:
receiving a character code, wherein the character code indicates one of an alphanumeric character and a graphic element;
determining a base glyph corresponding to the received character code;
determining if color is supported by a platform for rendering a glyph based on the received character code;
if color is supported, determining one or more replacement glyphs associated with the base glyph;
determining a color palette for each of the replacement glyphs;
rendering the glyph corresponding to the character code by combining the one or more replacement glyphs in z-ordered layers and applying the color palette; and
employing font hinting on colored elements in the combined glyph to improve a display of color on different devices or application user interfaces.

19. The computer-readable memory device of claim 18, wherein the instructions further comprise:
employing the font hinting to one or more of: simplify used colors, remove one or more colors, and accentuate one or more colors.

20. The computer-readable memory device of claim 18, wherein the instructions further comprising:
employing the font hinting to remove an entire color layer for a selected one of a font size and a resolution range.
